(19) United States
(12) Patent Application Publication
(10) Pub. No.: US 2014/0284225 A1
(43) Pub. Date: Sep. 25, 2014

(54) Paint and Craft Palettes and Case

(71) Applicant: Sherry Davis, Boerne, TX (US)

(72) Inventor: Sherry Davis, Boerne, TX (US)

(21) Appl. No.: 14/216,658

(22) Filed: Mar. 17, 2014

Related U.S. Application Data
(60) Provisional application No. 61/794,975, filed on Mar. 15, 2013.

(51) Int. Cl. B44D 3/02; B44D 3/14

(52) U.S. Cl. CPC B44D 3/02; B44D 3/14
USPC 206/1.8

(57) ABSTRACT

A paint palette with tray and accessory components having releasable bonding surfaces such as magnets and metallic layers, layers of sticky adhesive, static cling elements, or layers of other types of chemical or mechanical bonding surfaces. The palette components include paint pans, mix/wash pans, note stands, dividers, water container, and laminated value charts, all with bonding surfaces that adhere to and may be repositioned on the tray components. The paint pans and mix/wash pans are preferably stackable, of varying size and depth, some with slanted opening for ease of access to paint, and at least one rough exterior wall for labeling. A second embodiment uses multiple paint palettes in a modular system for use with mixed media. The palettes may be repositioned and held in place by magnets on the palette sides. The palettes are stackable and may be stored and transported in an adjustable carrying case.

### CROSS REFERENCES TO RELATED APPLICATIONS

This application claims the benefit under Title 35 United States Code §119(e) of U.S. Provisional Application 61/794,975 filed Mar. 15, 2013 the full disclosure of which is incorporated herein by reference.

### BACKGROUND OF THE INVENTION

1. Field of the Invention

The present invention relates generally to palettes and cases for art materials. Specifically, the present invention relates to a paint and craft palettes and case having magnetic or adhesive pans and accessories for interchangeably storing and positioning a variety of paints and painting accessories for use.

2. Description of the Related Art

In the past, artists have utilized various types of paint boxes and palettes. Most of these containers have numerous fixed receptacles for the paints and a limited space for sizable wash puddles and color mixing. Typically, there is a small area for storage of paint brushes and other materials and minimal or no area for wash pans. Artists customarily experience difficulties when transporting their palettes and other supplies to classes or locations where they desire to paint. The carriers used in the past are generally cumbersome, because their tools are in random sizes and shapes, making them impossible to stack neatly for transportation. They also offer limited areas for the mixing of paints, the variety of usage, and the manipulation of other supplies.

Many of the palettes and carriers in the prior art lack desired features such as quick setup with a full array of paints readily available for use. Such containers fail to provide one versatile case having readily accessible paints, brushes, storage areas, mix/wash pans, multiple media tools, and palette. It would be desirable to have a palette and carrier providing adequate storage, plentiful mixing space, multiple wash areas, and simplified cleanup.

Moreover, the palettes and carriers of the prior art have a fixed set of paints, requiring the artist to remove the paint from the pan in order to replace it with a different paint. An experienced artist may wish to use a completely different set of paints depending on the particular project or location. It would also be desirable to have a paint palette and carrier which enabled the artist to exchange one or more of the paint pans quickly and easily without waste or mess and to readily store the other pan(s) for future use.

It would also be advantageous to have a modular system for a set of palettes that could be arranged according to the needs of the artist and the specific media being used. A variable number of modular palettes could be utilized depending on the artist's project. It would be desirable to have an adjustable yet secure carrier into which one or more of the modular palettes could be placed for storage and transport.

### SUMMARY OF THE INVENTION

The present invention provides multiple embodiments of a paint and craft palette and case. The paint and craft palettes releasably retain various components typically used for art and craft projects.

One embodiment of the palette and case of the present invention provides a paint palette and carrier having magnetic or adhesive pans and accessories for interchangeably storing, positioning, and transporting a variety of paints and painting accessories for use. Repositionable paint pans, mix/wash pans, as well as a note stand and laminated value chart are interchangeably and removably adhered to base and lid trays. The base and lid trays may be metal, white enamel coated metal, acrylic, or other plastic material. The trays may serve as washable palette surfaces. The base and lid trays may be folded together for secure storage when not in use.

A second embodiment of the paint palette and case of the present invention utilizes the same magnetic or adhesive pans and accessories for interchangeably storing, positioning, and transporting a variety of paints and art accessories for use. Repositionable paint pans, mix/wash pans, as well as a note stand and laminated value chart are interchangeably and removably adhered to the palettes. In this embodiment the palettes may also be metal, white enamel coated metal, acrylic, or other plastic material and serve as washable palette surfaces.

This embodiment, however, is designed to additionally facilitate the use of multiple paint palettes. The multiple paint palettes may be positioned in a variety of contiguous positions, held in place by magnets positioned at the sides of the palettes. Each of the palettes has a ridged base to provide proper fit and stability when stacked. When not in use, the palettes may be stacked and placed in an adjustable carrying case where they are held securely in place. The handle on the carrier is ergonomically designed to naturally tilt the carrier backwards for stability when being carried.

In both embodiments, additional accessories such as sponge sheets, brushes, and mini-palettes may be stored in the palette base. The paint pans and mix/wash pans are preferably stackable and of varying size and depth. Some of the paint pans have a sloping cup design to confine the liquid paint to the bottom of the pan while giving a convenient surface for the removal of excess paint from the artist's brush. The pans have at least one rough exterior wall suitable for labeling. The artist may exchange and/or re-arrange one or more of these components quickly and easily. Removable adhesive paint palette dividers may be utilized to create discrete surface areas of varying sizes, for the separation of pure color washes from other color mixes, all according to the project requirements and the quantity of color choices. The palette dividers may be disposable or washable and reusable.

The present invention eliminates the problem in the prior art of fixed paint receptacles and limited palette space and area for mix/wash pans. The palettes and carrier of the present invention are highly versatile, combining portability and compact design with versatility of components, ease of setup, and spaciousness of work area. The paint pans, brushes, storage areas, mix/wash pans, and palettes are conveniently arranged to provide plentiful mixing space, multiple wash areas, and simplified cleanup with ample storage for all accessories. In the first embodiment, the hinged design of the base and lid allow the palette to be folded when not in use, with the accessories conveniently stored inside. The modular design of the palettes of the second embodiment allows them to be easily stacked in the carrier and transported in a compact and secure manner.

The present invention permits the artist to use a different set of paints as frequently as desired with very little effort. The paint does not need to be removed from the pan in order to replace it with a different paint. Thus, the paint palettes and carrier of the present invention allow the artist to exchange one or more of the paint pans quickly and easily without waste or mess and readily store the other pan(s) for future use. Moreover, the artist is able to design a customized workspace according to the requirements of a particular project.

### BRIEF DESCRIPTION OF THE DRAWINGS

FIG. 1 is a perspective view of the palette base component of the paint palette system of the present invention.

FIG. 2 is a perspective view of the palette lid component of the paint palette system of the present invention.

FIG. 3 is a perspective view of an open arrangement of the palette base component aligned with and attached to the palette lid component of the paint palette system of the present invention.

FIG. 4 is a perspective view of a closed arrangement of the palette base component and palette lid component of the paint palette system of the present invention.

FIG. 5 is a top plan view of the paint palette system of the present invention showing a majority of the discrete components in the system.

FIG. 6 is an assembly view of an array of paint pans and paint compound elements structured for use in conjunction with the paint palette system of the present invention.

FIG. 7 is an assembly view of an array of mix/wash pans structured for use in conjunction with the paint palette system of the present invention.

FIG. 8 is a top plan view of a laminated value chart structured for use in conjunction with the paint palette system of the present invention.

FIG. 9 is a perspective view of the closed paint palette system of the present invention showing the manner in which the exterior surface may be utilized with a number of the individual components in the system.

FIG. 10 is a perspective view of an alternate preferred embodiment of the palette component of the paint palette system of the present invention.

FIG. 11 is a side view of an alternate preferred embodiment of the palette component and lid of the paint palette system of the present invention.

FIG. 12 is a bottom view of an alternate preferred embodiment of the palette component of the paint palette system of the present invention.

FIG. 13 is a perspective view of an alternate preferred embodiment of the palette component of the paint palette system of the present invention in stacked configuration.

FIG. 14 is a side view of an alternate preferred embodiment of the palette component of the paint palette system of the present invention in stacked configuration.

FIG. 15 is a top plan view of an alternate preferred embodiment of the palette component of the paint palette system of the present invention in an open, attached configuration.

FIG. 16 is a perspective view of an alternate preferred embodiment of the palette component of the paint palette system of the present invention with clip board component magnetically attached.

FIG. 17 is a perspective view of the carrying case of the present invention.

FIG. 18 is a perspective view of the removable paint palette dividers of the present invention.

FIG. 19 is a perspective view of two preferred embodiments of the paint pans of the present invention.

### DETAILED DESCRIPTION OF THE PREFERRED EMBODIMENTS

The present invention discloses multiple embodiments of a paint and craft palette and case. The paint and craft palettes releasably retain various components which are useful for art and craft projects. The following paragraphs contain detailed descriptions of two embodiments of the palette and case of the present invention.

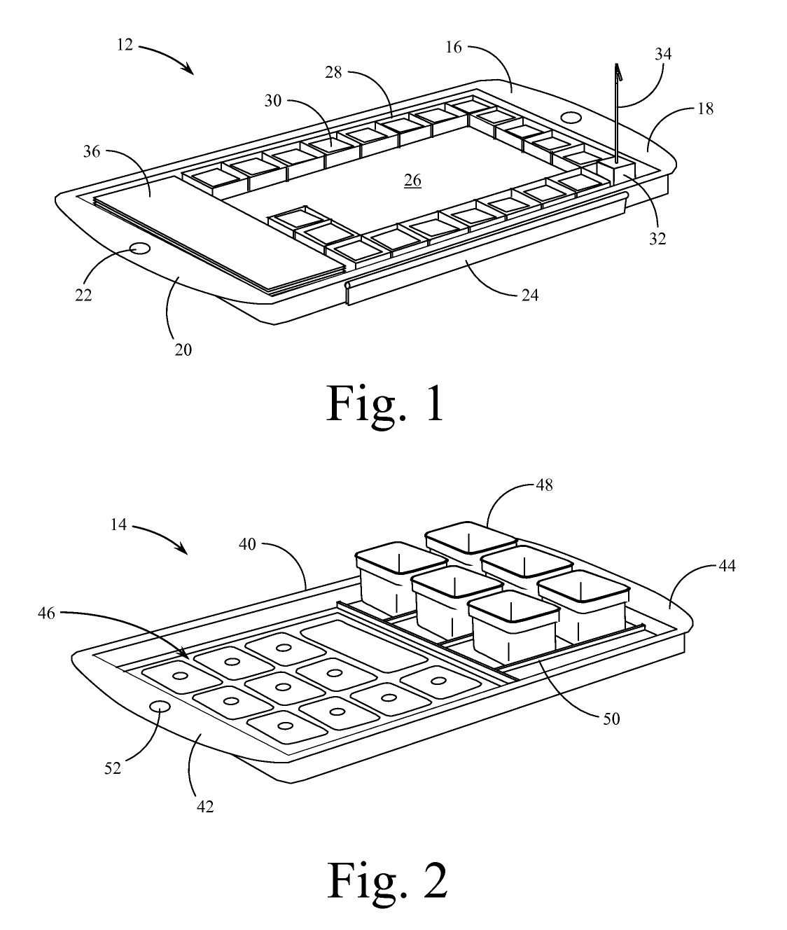

Reference is made first to FIGS. 1 & 2 for detailed descriptions of the basic components of a first embodiment of the paint palette system of the present invention. FIG. 1 is a perspective view of palette base 12 forming the bottom half of the clam shell structure of the overall paint palette system 10. Palette base 12 is generally constructed of metal tray 16, having handle extensions 18 & 20. Positioned on handle extensions 18 & 20 are lid closure magnets 22 which align with and secure to palette lid 14 (shown in FIG. 2) when the system 10 is closed.

Metal tray 16 of palette base 12 also incorporates alignment magnet/hinge 24, the function of which is described in more detail below. The primary feature of palette base 12 is palette surface 26 which comprises a smooth, wipeable, preferably white, surface on which paints may be mixed, prepared, and used as with a typical painter's palette surface. Palette surface 26 may preferably be a white enamel coating covering the metal surface component (ferromagnetic metal material) of metal tray 16. Alternately, palette surface 26 and tray 16 may be made from plastic.

Arranged around the edge of metal tray 16, on top of palette surface 26, is an array of paint pans 28 each incorporating color paint compounds 30. Depending upon the type of paint being utilized, these paint compounds 30 are preferably semi-solid blocks or tubed paints that are positioned within the plastic or metal paint pans 28. The magnetic character of paint pans 28 and the manner in which they may be magnetically positioned on metal tray 16 is described in more detail below. Alternately, the paint pans 28 may be removably and adhesively attached to plastic surface 26 with any of a variety of sticky adhesives, static cling elements, and other types of chemical and mechanical bonding surfaces.

Also included on palette base 12 in association with a perimeter space on metal tray 16 is note stand base 32, which itself preferably has a magnetic component to it. Extending from note stand base 32 is note clip 34 which provides a means for securing a note card or note paper to facilitate the artist's use of the palette or the painting of a particular work. Alternately, note stand base 32 may have a removable adhesive component for attachment.

Also positioned within metal tray 16 at one end of palette base 12 may preferably be a stack of sponge sheets 36. Such sponge sheets 36 are typically used in conjunction with water color painting of the type preferable for the paint palette system of the present invention. Other materials may be placed in the area shown with sponge sheets 36 in FIG. 1. The arrangement of components shown in FIG. 1 is by way of example only, as the entire interior base of tray 16 is preferably metal, whereby the magnetic components of paint pans 28 allow them to be positioned and repositioned anywhere on paint palette surface 26. Likewise, the artist may chose to position note stand base 32 and sponge sheets 36 in any convenient area within metal tray 16 and to be repositioned by the artist as necessary. Alternately, the paint pans 28 may be positioned and repositioned with removable adhesive components.

Reference is next made to FIG. 2 for a detailed description of palette lid 14 of paint palette system 10. Palette lid 14 is preferably structured in a manner similar to palette base 12 having metal lid tray 40 with handle extensions 42 & 44. Preferably sized the same as palette base 12, palette lid 14 provides an aligned and secure lid to cover the components (in particular paint pans 28 and paint compounds 30) when these components do not need to be accessed. Lid closure magnets 52 match with base closure magnets 22 shown in FIG. 1 to align with and secure handle extensions 42 & 44 of palette lid 14 shown in FIG. 2. Such alignment and securing magnetic means may comprise magnets on one component with metal surfaces on the other, or magnets on each component with reverse polarity for attachment (as shown in FIGS. 1 & 2).

Palette lid 14 is generally structured to provide for the placement of mix/wash pans 48 which are preferably larger than paint pans 28 shown in FIG. 1. Mix/wash pans 48 may be positioned on the base of metal lid tray 40 within the areas defined by base ridge separators 50. Base ridge separators 50 facilitate the positioning of mix/wash pans 48 as well as the retention of any spilled paint, water, or other liquids from mix/wash pans 48.

Also positioned within palette lid 14 is value chart 46, generally constructed of a clear laminated sheet of cardstock printed or colored with a value chart as is typical in the field of art. While the value chart itself is not unique, the laminated character of the chart which allows the artist to paint directly on the sheet and check the paint's value, along with its use of a magnetic foundation are unique and allow it to be utilized in conjunction with the metal tray structures of the present invention. Value chart 46 may be removed from metal lid tray 40 and used by depositing small amounts of paint on the laminated surface for comparison and identification of the color value or contrast value of the paint being used. The laminated surface may then be washed and cleaned for subsequent use. Use of value chart 46 may of course be made while it is positioned within metal lid tray 40 or when it is removed for use in conjunction with the art work being created (for example).

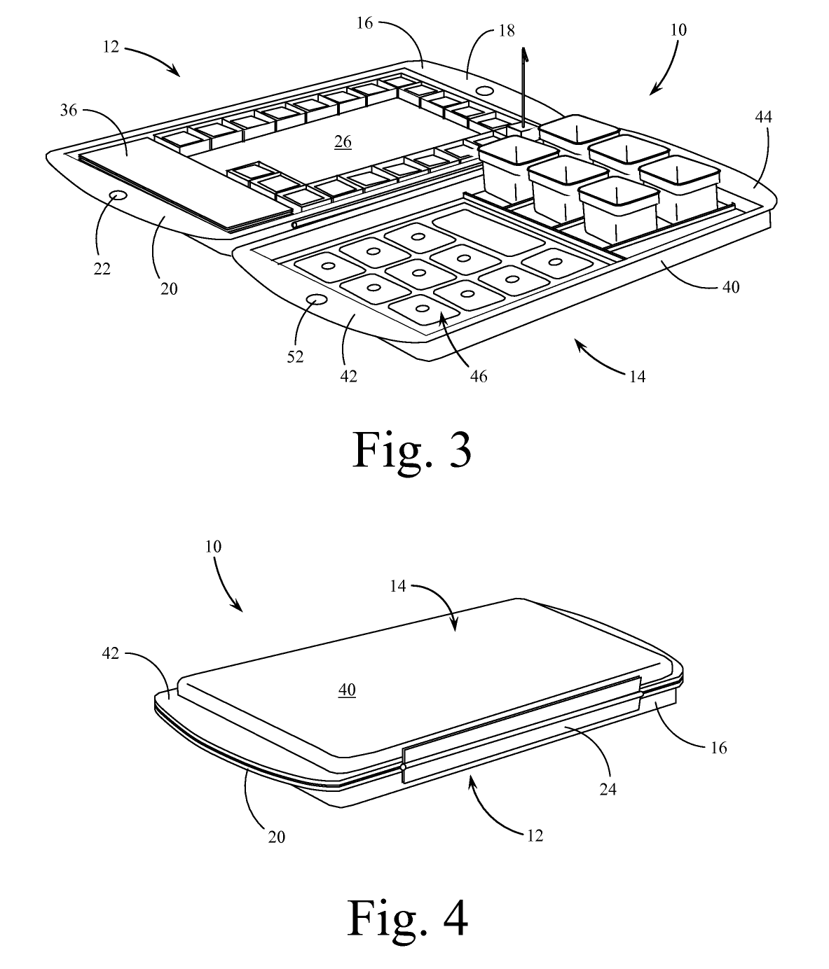

Reference is next made to FIGS. 3 & 4 which demonstrate the manner in which the components of the system of the present invention may be oriented and aligned for use when open, or oriented and aligned for containment when closed. FIG. 3 shows palette base 12 open and aligned next to palette lid 14 utilizing alignment magnet/hinge 24 as a manner of orienting and securing the two components together. Alignment magnet/hinge 24 may be a simple strip of magnetic material that allows palette base 12 be secured next to palette lid 14 when the components are open on a flat surface.

Alternate embodiments of alignment magnet/hinge 24 may include a long piano type hinge securing two magnet sections together, or a flexible section of magnetic material that allows palette base 12 and palette lid 14 to hingedly pivot with regard to one another in a manner that allows the user to close palette lid 14 over palette base 12 as shown in FIG. 4. Alternately, the base and lid components may simply be separable from the magnetic strip 24 and placed one on top of the other (palette lid 14 on top of palette base 12) again in the manner shown in FIG. 4.

In either case, it is anticipated that a number of the internal components may be removed and stored separately to permit the tight closure of lid 14 against palette base 12. Mix/wash pans 48 (see FIG. 2) may, for example, be removed from palette lid 14 and attached to the top of the closed palette through its magnetic/adhesive property or secured in a separate container. Likewise, note stand base 32 with note clip 34 may be tilted downward into palette base 12 when palette lid 14 is secured on top. Other painting accessories may be included within the closed structure of the paint palette system shown in FIG. 4, such as paint brushes, pencils, and the like. Small half palettes may likewise be incorporated into the closed lid construction shown in FIG. 4 when incorporated as optional components to the overall paint palette system (see FIG. 9 below).

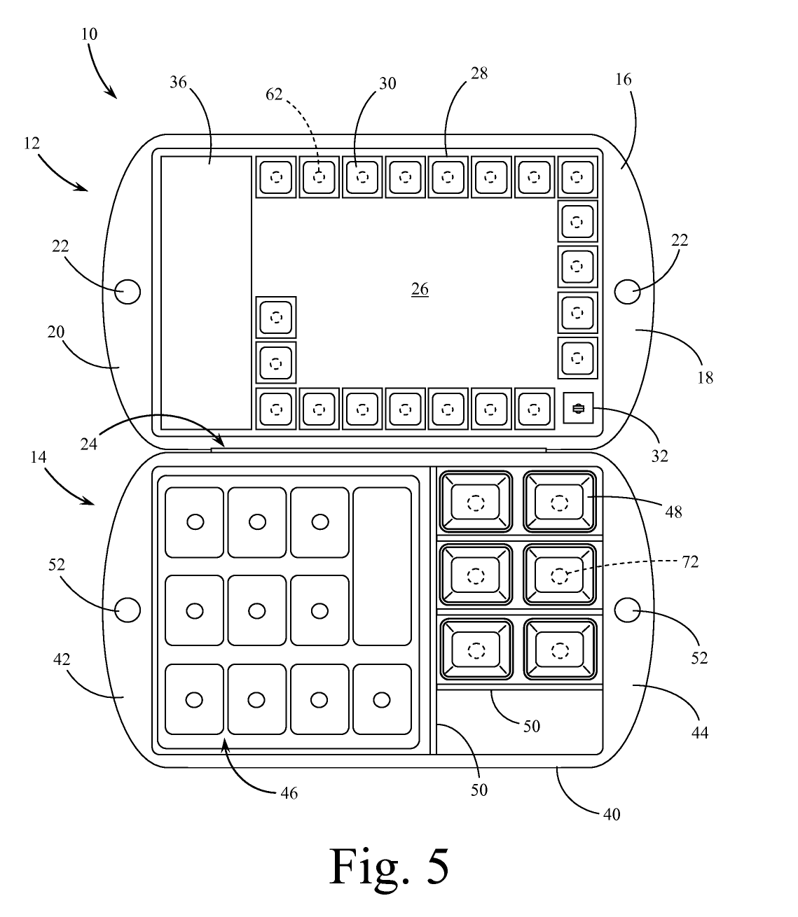

Reference is next made to FIG. 5 for a top plan view of the components of the system generally shown in FIGS. 1 & 2 disclosing in greater detail the manner in which these components may be positioned within the flat metal tray structures of the paint palette system. Palette base 12 is generally constructed of metal tray 16, having handle extensions 18 & 20. Positioned on handle extensions 18 & 20 are lid closure magnets 22. Metal tray 16 of palette base 12 also incorporates alignment magnet/hinge 24, which in the view of FIG. 5, is shown to be attached to both palette base 12 and palette lid 14. Central within palette base 12 is palette surface 26 which comprises a surface for mixing, preparing, and using paints. Palette surface 26 again is preferably a white enamel coating covering the surface of metal tray 16. However, as noted previously, palette surface 26 may alternately be made of plastic.

Arranged around the edge of metal tray 16, on top of palette surface 26, are a number of paint pans 28 that each hold a color paint compound 30. Paint pans 28 preferably incorporate magnets 62 which allow them to be magnetically positioned and repositioned on metal tray 16. The paint pans 28 may alternately be made of plastic having removable adhesive bonding surfaces for positioning on the plastic tray 16. These surfaces may be any of a variety of sticky adhesives, static cling elements, and other types of chemical and mechanical bonding surfaces. Also included on palette base 12 is note stand base 32, with note clip 34 which provides a means for securing a note card or note paper for easy viewing by the artist. Finally positioned within metal tray 16, at one end of palette base 12 is a stack of sponge sheets 36. Once again, other types of materials may be placed in this.

Palette lid 14 is again shown to be structured with a geometry similar to that of palette base 12 having metal lid tray 40 with handle extensions 42 & 44. Internally, palette lid 14 is generally structured to provide for the placement of mix/wash pans 48 which may be positioned on the base of metal lid tray 40 within the areas defined by base ridge separators 50. Mix/wash pans 48 preferably incorporate magnets 72 that allow them to be magnetically positioned and repositioned on metal lid tray 40. Base ridge separators 50 position mix/wash pans 48 and help retain any spilled paint, water, or other liquids.

Finally positioned within palette lid 14 is value chart 46, the character and function of which is described in more detail below. Value chart 46 may be used while it is positioned within metal lid tray 40 or may be removed for use in conjunction with the art work being created or when sampling paints to be used with the artwork.

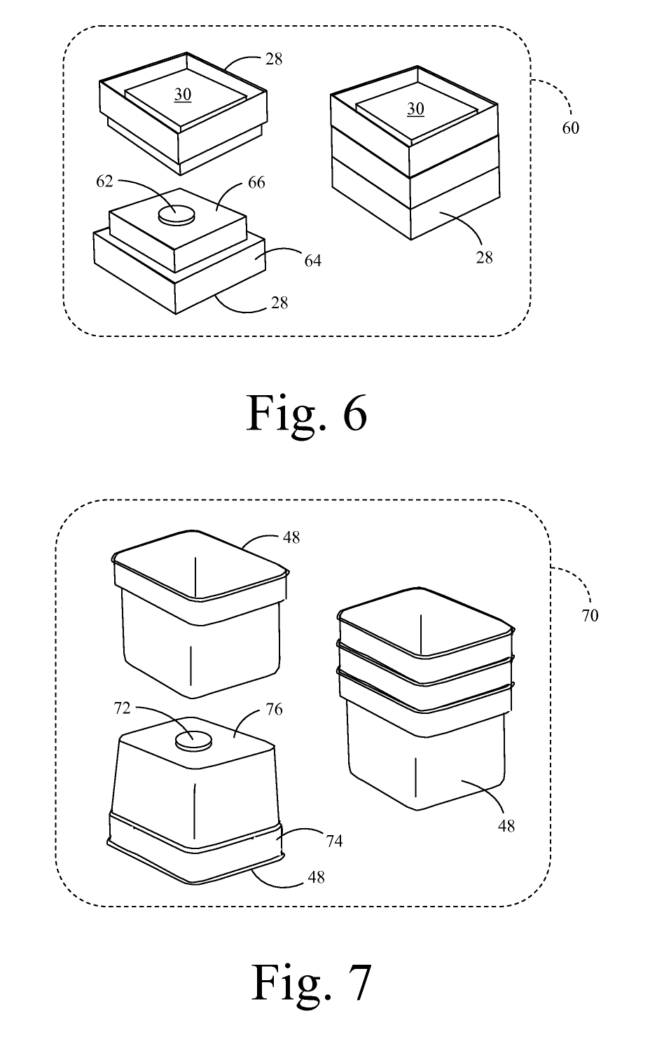

Reference is next made to FIGS. 6 & 7 for detailed descriptions of preferred paint pan structures and mix/wash pan structures for the system of the present invention. FIG. 6 shows an array 60 of paint pans 28 that are structured to be positioned on and secured to the metal tray components of the system of the present invention. An individual paint pan 28 incorporates a quantity of paint compound 30 in solid or semi solid form. If the paint being utilized is watercolor, paint compound 30 may be a block or quantity of tubed watercolor paint material.

Each paint pan 28 is preferably constructed having a geometry that allows it to be stackable in conjunction with additional paint pans. Such a stackable configuration is generally established with a smaller geometry base 66 positioned beneath a larger geometry walled rim 64. In this manner, a number of paint pans 28 may be stacked together as shown in FIG. 6. Each paint pan 28 preferably incorporates a magnet 62 that allows it to be removably secured to the metal tray through the palette surface. Orientation of magnet 62 is preferably consistent so as to allow stacking of the components as shown in FIG. 6. In other words, although magnets 62 do not come into direct contact with each other when stacked, it is preferable that the north pole of the magnets be consistently oriented in the same direction, such as downward from the base, so as to be attractively aligned with the south pole face of the magnet from the paint pan below.

Similar structures are associated with the mix/wash pans 48 shown in FIG. 7. Array 70 of mix/wash pans 48 are preferably plastic containers with or without lids that likewise have a geometry that allows them to be stackable as shown. Generally, this means a base 76 with a geometry smaller than the rim walls 74 of the pan 48. Similar considerations are given to magnets 78 positioned on mix/wash pans 48 for use in conjunction with their placement on the metal tray surfaces of the paint palette system, as well as their ability to be stacked as shown.

It is preferable for at least some of the mix/wash pan structures and some of the paint pan structures to have a 15% tilt to their opening in order to allow a paint brush to more easily drag the color paint out of the pans. These paint pans and mix/wash pans are preferably made of a number of different sizes and depths to allow for variability in the brush size. Deeper pans may preferably have individual lids which, when the pans are used for large amounts of liquefied paint, will prevent evaporation overnight. Preferably the paint pans and the mix/wash pans will also have at least one rough exterior side wall in order to facilitate labeling the paint color contained within the pan.

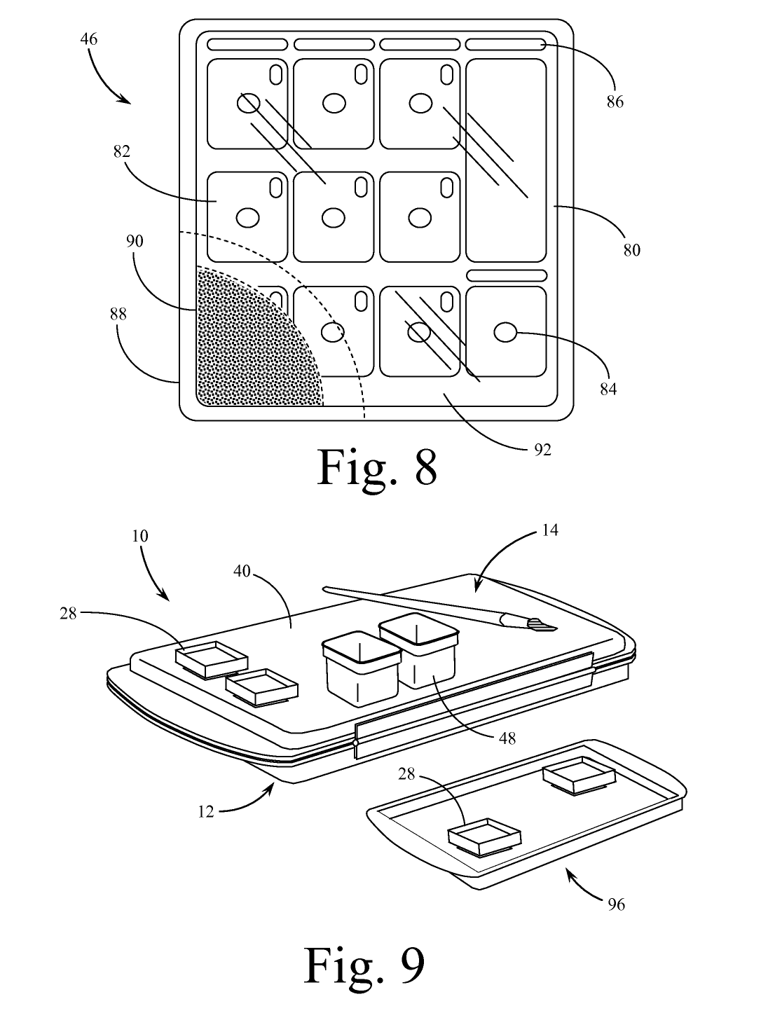

Reference is next made to FIG. 8 which is a top plan view of the laminated value chart 46 of the system of the present invention. Value chart 46 is preferably a sheet of paper or cardstock 80 printed or painted with gradations of color value represented with samples 82, each with a white area 84 in the center. Typically nine areas of color value are represented and labeled 86 along with a pure black and a pure white area. The paper or cardstock 80 is backed with a sheet of magnetic material 90 and the combination is then sealed within clear laminate sheets 88 & 92. A portion of these layers are cut away in FIG. 8 and shown in broken line form. After the artist matches the value of a color being used, easy clean up of the surface of the value chart allows for subsequent use. The magnetic sheet that the value chart is formed from can be easily removed from the palette allowing the metal surface of the palette or the palette lid to be utilized for alternate functions.

Reference is finally made to FIG. 9 for a perspective view of the closed system of the present invention with palette base 12 covered by palette lid 14. Because the metal tray components 16 & 40 of this system likewise present exposed flat metal surfaces, each of the individual components structured with magnets within the system may be placed and secured on the external surfaces of the closed paint palette system. These individual components could comprise individual paint pans 28, or one or more individual mix/wash pans 48.

The preferred embodiment of the present invention will also allow for one or more optional half sized palettes 96 designed to have many of the same features as palette base 12 and palette lid 14. These half size palettes 96 would be structured to also be adjoined to the larger palette surfaces while they are opened. The half size palettes serve the purpose of providing for additional color washing and mixing surfaces. The smaller palettes also serve as additional surfaces for placement of the magnetized water container and as a rest for wet brushes.

### ALTERNATE PREFERRED EMBODIMENT

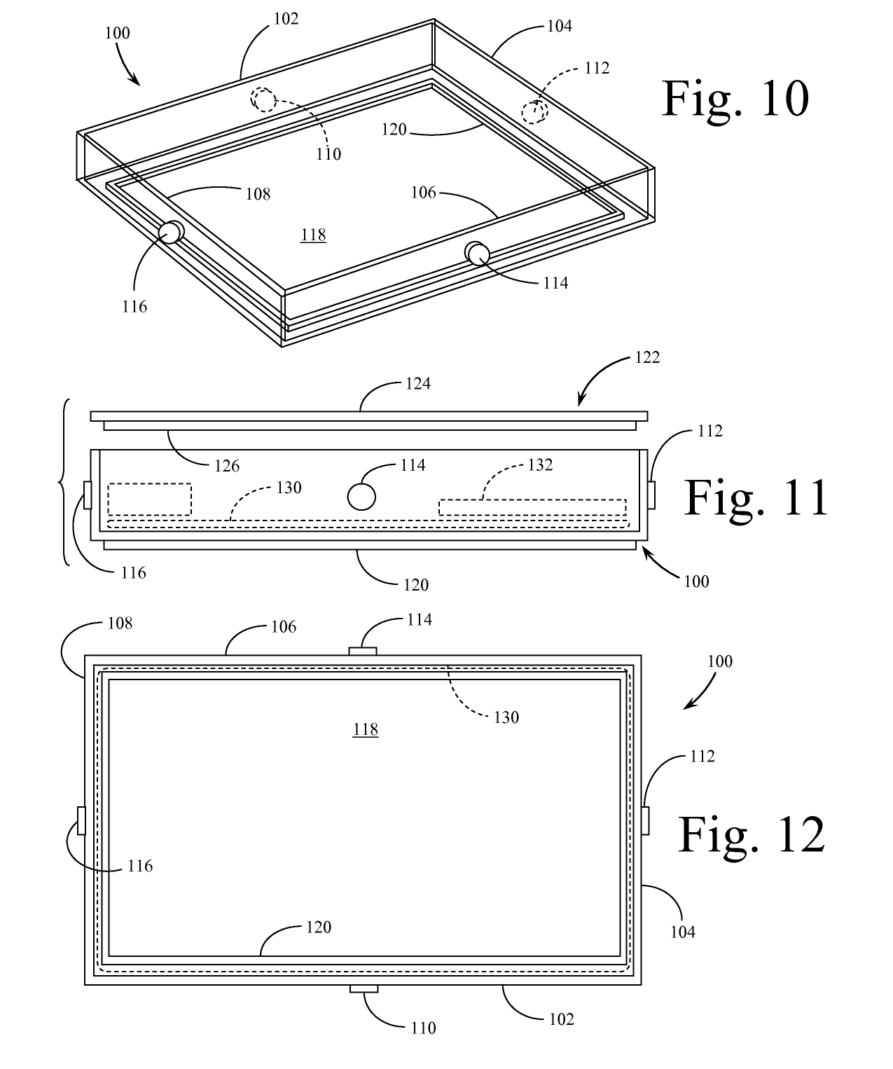

As described in the detailed description above, the first embodiment of the present invention is a palette base and lid having a base tray, lid tray, palette surface, paint pans, wash pans, and other accessories which are all removably detachable. As shown in FIGS. 10-17, the second embodiment of the present invention possesses the same functionality of all of the removably detachable discrete elements of the first embodiment. The magnetic, adhesive, or other bonding surfaces are equally appropriate and applicable to the alternate embodiment as described below.

The second embodiment discloses a modular system for a set of palettes that can be arranged according to the needs of the artist and the specific media being used. The palettes are aligned and secured with magnets located on the side walls of the palette units. A variable number of modular palettes can be utilized depending on the artist's project. The modular palettes can be stacked and placed in an adjustable and secure carrier for storage and transport.

Reference is made first to FIGS. 10, 11 & 12 for detailed descriptions of the basic components of a second embodiment of the paint palette system of the present invention. FIG. 10 is a perspective view of palette base 100 which forms the basic structural unit of the modular system of this embodiment. Palette base 100 is preferably constructed of a metal or plastic tray 118 having side walls 102, 104, 106, and 108. Positioned on side walls 102, 104, 106, and 108 are magnets 110, 112, 114, and 116 which align with and secure to similar magnets positioned on additional palette units (shown in FIG. 15) when multiple palette units are in use.

FIG. 11 is a side view of the alternate preferred embodiment of the palette component and lid of the paint palette system of the present invention. As shown in FIG. 11, associated with palette base 100 is palette lid 122 which is designed to fit snugly on top of palette base 100. Palette lid 122 has a top surface 124 and a bottom surface 126. Top surface 124 can function as an additional painting or craft surface. Bottom surface 126 is designed to fit onto the top of palette base 100. As shown in FIG. 11, palette base 100 has an inset base 120 designed to stack on top of a second palette base 100. The ridges of inset base 120 on the reverse side of the palette base 100 will also help hold the mattes and paper palettes in place during use. The reverse side of the palette base 100 can be used for the convenience of elevating the work surface or for eliminating the restrictive side walls during knife or brayer work. Also shown is bonding surface 130 which may be a metallic layer, or alternately, a layer of sticky adhesive, static cling element, or other type of chemical or mechanical bonding surface. Alternately, if the pans have an adhesive property, the palettes do not need to have a bonding surface. FIG. 11 shows painting accessory item 132 securely, yet removably, attached to bonding surface 130.

FIG. 12 is a bottom view of the alternate preferred embodiment of the palette component of the paint palette system of the present invention. The metal or plastic tray 118 of palette base 100 comprises a smooth, wipeable, preferably white, surface on which paints may be mixed, prepared, and used as with a typical painter's palette surface. Palette base 100 may preferably be a white enamel coating covering a metal surface component (ferromagnetic metal material). Alternately, palette base 100 may be made from acrylic plastic or some other type of plastic.

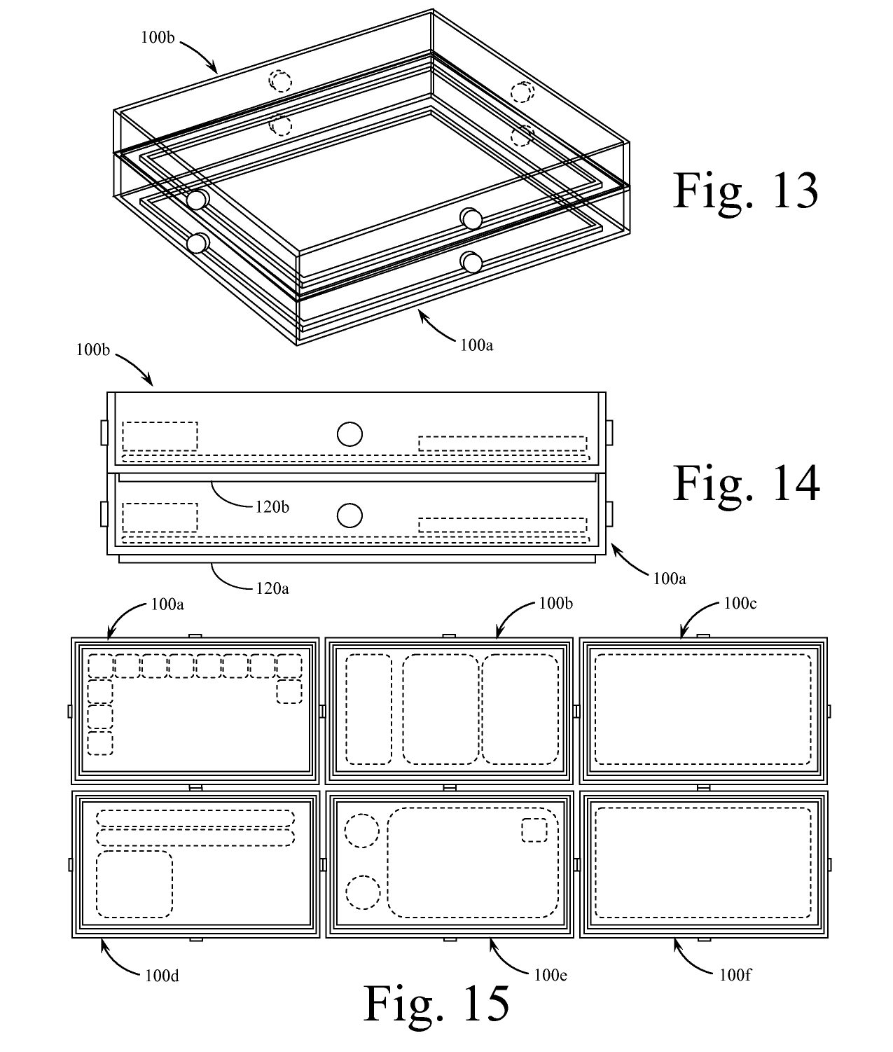

FIG. 13 is a perspective view of the alternate preferred embodiment of the palette component of the paint palette system of the present invention in stacked configuration. As shown in FIG. 13, palette base 100b is stacked upon palette base 100a. Multiple units of palette base 100 may be stacked upon one another to accommodate the needs of the user. FIG. 14 shows the side view of the palette component in stacked configuration with inset base 120b fitting onto the top of palette base 100a.

FIG. 15 is a top plan view of the palette component of the second embodiment of the paint palette system of the present invention in an open, attached configuration. As shown in FIG. 15, multiple units of palette base 100a-100f may be used concurrently to best meet the artist's needs. FIG. 15 shows one manner in which the palette base components of the system of the present invention may be oriented and aligned for use. Alternately, the palette base components may be oriented and aligned vertically, in an open square, or in any geometric configuration that is desired. The multiple palette bases 100a-100f shown in FIG. 15, are aligned next to one another and utilize the side magnets (110, 112, 114 & 116) to orient and secure the multiple components together.

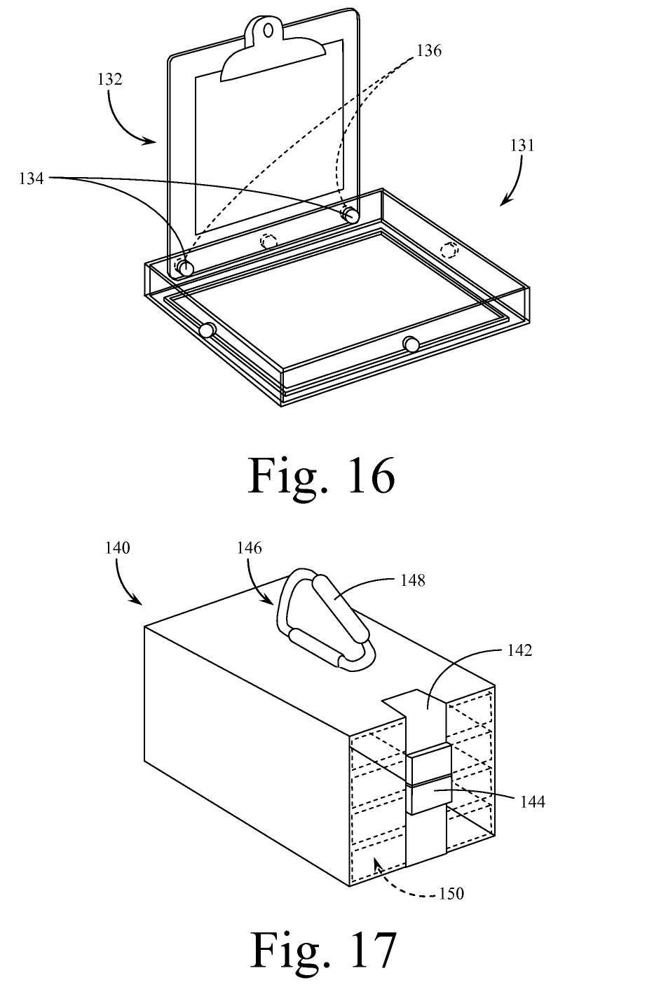

FIG. 16 is a perspective view of an alternate preferred embodiment of the palette component with clip board component magnetically attached. In FIG. 16, palette base 131 is configured to hold clip board 132 in a vertical position with magnets 134 on the clip board 132 aligned with magnets 136 on the side wall of palette base 131. In this position, clip board 132 is readily visible to the artist.

FIG. 17 is a perspective view of the carrying case 140 of the present invention. As shown in FIG. 17, carrying case 140 is designed to hold multiple units of palette base 150 in stacked configuration. The stack of palette bases 150 are inserted into carrying case 140 and secured with strap 142 and buckle 144. Carrying case 140 has a ring handle 148 with an elongated rear section 146 to position the weight of the contents away from the front of carrying case 140. This position takes the stress of the contents off of buckle 144 and toward the closed back of carrying case 140.

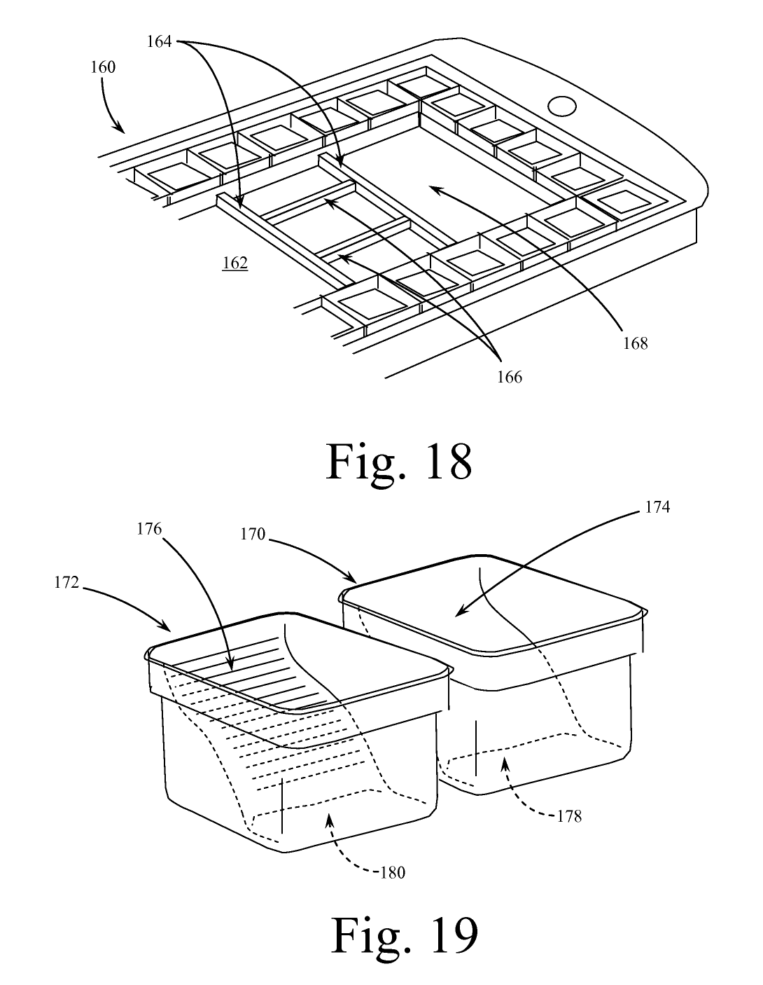

Applicable to both of the preferred embodiments described above, FIG. 18 shows a perspective view of removable paint palette dividers of the present invention. As shown in FIG. 18, dividers 164 and 166 can be placed on palette tray 162 of palette base 160 in a wide variety of positions. These dividers may be repositioned and removed. Additionally they may be disposable or alternately, may be washable and reusable. As shown by area 168, the artist may create paint palette areas of varying sizes to suit the requirements of a project.

FIG. 19 is a perspective view of two preferred embodiments of the paint pans of the present invention which may be used in either of the preferred embodiments described above. In FIG. 19, paint cup 170 is shown having base 178 and sloped wall 174. Sloped wall 174 is curved and smooth to remove dripping paint from the artist's brush. Also shown in FIG. 19 is paint cup 172 having base 180 and sloped wall 176. Sloped wall 176 is curved and ridged to facilitate removal of even more paint from the artist's brush.

Although the present invention has been described in conjunction with a number of preferred embodiments, those skilled in the art will recognize modifications to these embodiments that still fall within the scope of the present invention. Because paints, and in particular watercolor paints, are often sold in standardized pans or containers, an alternate implementation of the present invention would provide for magnets or other bonding surfaces that could be adhered to the bottom of such standardized containers. Preferably, however, paint compounds are incorporated (by the user) into the specifically structured pans of the present invention. The present invention may be manufactured as shown with all of the various components included. Alternately, the present invention may be implemented through the manufacture and sale of a kit of various elements that allow for the customization of the paint palette system according to the type of paint being used or the specific needs of the artist. All of these embodiments are anticipated to fall within the spirit and scope of the invention.

I claim:

1. A paint palette and carrier for interchangeably storing and positioning a variety of paints and painting accessories for use, the paint palette and carrier comprising:
a base tray comprised of ferromagnetic metal;
a lid tray comprised of ferromagnetic metal;
a plurality of paint pans having magnetic elements; and
a plurality of mix/wash pans having magnetic elements;
wherein the paint pans and mix/wash pans are repositionable, interchangeable, and magnetically adherent to the base and lid trays.

2. A paint palette and carrier for interchangeably storing and positioning a variety of paints and painting accessories for use, the paint palette and carrier comprising:
a base tray comprised of polymer plastic;
a liner in the base tray comprised of a bonding surface;
a lid tray comprised of polymer plastic;
a plurality of paint pans having a bonding surface; and
a plurality of mix/wash pans having a bonding surface;
wherein the paint pans and mix/wash pans are repositionable, interchangeable, and adherent to the base and lid trays.

3. A modular paint palette system and carrier for interchangeably storing and positioning a variety of paints and painting accessories for use, the paint palette system and carrier comprising:
at least two base trays each having a bottom portion with a bonding surface layer and an inset base for stacking, and four side walls having a magnet positioned on each wall;
a lid tray comprised of polymer plastic having an inset base for stacking;
a plurality of paint pans having a bonding surface;
a plurality of mix/wash pans having a bonding surface; and
a carrier for storing the at least two base trays;
wherein the paint pans and mix/wash pans are repositionable, interchangeable, and adherent to the base tray.

4. The modular paint palette system and carrier of claim 3, wherein the bonding surface layer comprises a ferromagnetic layer and the bonding surfaces of the plurality of paint pans and the plurality of mix/wash pans comprise magnetic elements.
